(19) United States
(12) Patent Application Publication
(10) Pub. No.: US 2026/0358896 A1
(43) Pub. Date: Nov. 12, 2026

(54) CONTROL INSTRUCTION GENERATION METHOD AND DEVICE, STORAGE MEDIUM, AND PROGRAM PRODUCT

(71) Applicant: Beijing Zitiao Network Technology Co., Ltd., Beijing (CN)

(72) Inventors: Mengqian LIU, Beijing (CN); Xujie TAO, Beijing (CN); Jia GUO, Beijing (CN); Shuo LIU, Beijing (CN); Jie LIN, Beijing (CN)

(21) Appl. No.: 19/660,915

(22) Filed: Apr. 28, 2026

(30) Foreign Application Priority Data
May 9, 2025 (CN) 202510600239.0

(51) Int. Cl. G06F 3/01; G06F 1/16; G06F 3/16

(52) U.S. Cl. CPC G06F 3/017; G06F 1/163; G06F 3/015; G06F 3/167

(57) ABSTRACT

A control instruction generation method and device, a storage medium, and a program product are provided. The method includes: acquiring sensing data collected by at least one sensor; determining gesture information according to the sensing data; and generating a corresponding control instruction according to the gesture information.

### CROSS-REFERENCE TO RELATED APPLICATION

This application claims the priority to and benefits of the Chinese Patent Application, No. 202510600239.0, which was filed on May 9, 2025. The aforementioned patent application is hereby incorporated by reference in its entirety.

### TECHNICAL FIELD

Embodiments of the present disclosure relate to the field of extended reality technologies, and in particular, to a control instruction generation method and device, a storage medium, and a program product.

### BACKGROUND

As a new type of wearable device, an intelligent ring not only has the decorative function of a traditional ring, but also integrates various advanced technical elements, bringing more convenience and fun to users' lives.

In the related art, a control instruction is usually generated by touching a surface of the intelligent ring.

However, the traditional display manner of the prompt information of the input box has the technical problem that in many scenarios, the user may not have a free finger to perform a touch action on the surface of the worn ring, which is inconvenient to use and poor in flexibility.

### SUMMARY

Embodiments of the present disclosure provide a control instruction generation method and device, a storage medium, and a program product to improve the flexibility of using an intelligent ring.

In a first aspect, embodiments of the present disclosure provide a control instruction generation method, which is applied to an intelligent ring, where the intelligent ring includes at least one sensor, and the method includes: acquiring sensing data collected by the at least one sensor; determining gesture information according to the sensing data; and generating a corresponding control instruction according to the gesture information.

In a second aspect, embodiments of the present disclosure provide a control instruction generation device, including: an acquiring module, configured to acquire sensing data collected by at least one sensor; a determination module, configured to determine gesture information according to the sensing data; and a generation module, configured to generate a corresponding control instruction according to the gesture information.

In a third aspect, embodiments of the present disclosure provide an electronic device, including: a processor and a memory; the memory stores a computer-executable instruction; and the processor executes the computer-executable instruction stored in the memory to cause at least one processor to execute the control instruction generation method according to the above first aspect and various possible designs of the first aspect.

In a fourth aspect, embodiments of the present disclosure provide a computer-readable storage medium, where a computer-executable instruction is stored in the computer-readable storage medium, and when the computer-executable instruction is executed by a processor, the control instruction generation method according to the above first aspect and various possible designs of the first aspect is implemented.

In a fifth aspect, embodiments of the present disclosure provide a computer program product, including a computer program, where when the computer program is executed by a processor, the control instruction generation method according to the above first aspect and various possible designs of the first aspect is implemented.

For the control instruction generation method and device, the storage medium, and the program product provided by the embodiments, the method includes: acquiring the sensing data collected by the at least one sensor; determining the gesture information according to the sensing data; and generating the corresponding control instruction according to the gesture information. According to the method provided by the present disclosure, the corresponding gesture information is obtained through recognition based on multimodal data collected by the at least one sensor, and the control instruction is generated based on the gesture information, thereby ensuring the accuracy of gesture recognition, improving the flexibility of controlling the intelligent ring, and thus improving the user experience.

### BRIEF DESCRIPTION OF DRAWINGS

In order to more clearly describe the technical solutions in the embodiments of the present disclosure or in the prior art, the following briefly introduces the drawings that need to be used in the description of the embodiments or the prior art. Obviously, the drawings in the following description are some embodiments of the present disclosure, and for those of ordinary skill in the art, other drawings may also be obtained from these drawings without any creative effort.

FIG. 1 is a schematic diagram of an application scenario of a control instruction generation method provided by embodiments of the present disclosure;

FIG. 2 is a first schematic flowchart of a control instruction generation method provided by embodiments of the present disclosure;

FIG. 3 is a second schematic flowchart of a control instruction generation method provided by embodiments of the present disclosure;

FIG. 4a is a schematic diagram of a cache and upload mechanism for sensing data provided by embodiments of the present disclosure;

FIGS. 4b-4f are schematic diagrams of training samples of inertial sensing data provided by embodiments of the present disclosure;

FIGS. 4g-4h are schematic diagrams of training samples of audio sensing data provided by embodiments of the present disclosure;

FIGS. 5a-5b are schematic diagrams of waveforms of sensing data provided by embodiments of the present disclosure;

FIG. 6 is a schematic diagram of the principle of preventing instruction retransmission provided by embodiments of the present disclosure;

FIG. 7 is a structural block diagram of a control instruction generation device provided by embodiments of the present disclosure; and

FIG. 8 is a schematic diagram of a hardware structure of an electronic device provided by embodiments of the present disclosure.

### DETAILED DESCRIPTION

In order to make the purposes, technical solutions and advantages of the embodiments of the present disclosure clearer, the technical solutions in the embodiments of the present disclosure will be described clearly and completely below in combination with the drawings in the embodiments of the present disclosure. Obviously, the described embodiments are part of the embodiments of the present disclosure, but not all of the embodiments. Based on the embodiments in the present disclosure, all other embodiments obtained by those of ordinary skill in the art without creative efforts belong to the protection scope of the present disclosure.

As a representative of mainstream intelligent devices in the future, an intelligent ring not only has a fashionable wearing attribute, but also carries an artificial intelligence (AI) assistant function.

In the related art, a user may tap or press a surface of the intelligent ring with a finger (e.g., a thumb) that is not wearing the ring to generate a control instruction to implement interaction with the AI assistant of the intelligent ring, such as waking up the device or executing a voice instruction.

However, in many real scenarios, the user's thumb may be occupied (e.g., holding an item or operating other devices) and cannot effectively tap the ring surface to complete the operation. This limitation poses challenges to the usability and user experience of intelligent devices.

In order to solve the above technical problem, it is studied and found that when the thumb is occupied, it is inconvenient to apply force to the surface of the intelligent ring, then gesture recognition may be used, and instead of directly applying force to the intelligent ring, interaction may be triggered by other fingers, palm or slight hand movements. For example, tapping with the index finger, swinging the hand, and cooperation between the index finger and the middle finger may trigger control instructions. It is also found that the recognition of these gestures that are not directly applied to the surface of the intelligent ring imposes higher requirements on gesture recognition technology, especially in terms of accurate recognition and environmental adaptability. The gesture recognition manner using single-modal data (such as IMU data) has obvious limitations, which may lead to inaccurate gesture recognition, thus negatively affecting the user experience. Therefore, multimodal data may be used to improve the accuracy of gesture recognition. Based on this, embodiments of the present disclosure provide a control instruction generation method.

FIG. 1 is a schematic diagram of an application scenario of a control instruction generation method provided by embodiments of the present disclosure. As shown in FIG. 1, an intelligent ring 100 includes a controller (not shown) and at least one sensor connected to the controller, such as a first sensor 101 and a second sensor 102. Optionally, the first sensor 101 may be an inertial sensor, and the second sensor 102 may be an audio sensor.

In a specific implementation process, assuming that a user holds an object with the left hand and the right thumb is injured and cannot touch the surface of the intelligent ring 100 to generate a corresponding control instruction, the user may make a specific gesture, such as tapping the desktop with the index finger or making a fist. The sensing data collected by the at least one sensor is acquired by the controller of the intelligent ring 100, such as inertial sensing data collected by the first sensor 101 and a sound signal collected by the second sensor 102. The gesture information is determined according to the sensing data, such as the index finger wearing the intelligent ring continuously tapping the desktop twice, and then the corresponding control instruction is generated according to the gesture information, such as a wake-up instruction of the intelligent ring. According to the control instruction generation method provided by the embodiments of the present disclosure, the corresponding gesture information is obtained through recognition based on the multimodal data collected by the at least one sensor, and the control instruction is generated based on the gesture information, thereby ensuring the accuracy of gesture recognition, improving the flexibility of controlling the intelligent ring, and thus improving the user experience.

It should be noted that the schematic diagram of the scenario shown in FIG. 1 is only an example, and the control instruction generation method and the scenario described in the embodiments of the present application are intended to illustrate the technical solutions of the embodiments of the present application more clearly, and do not constitute a limitation on the technical solutions provided by the embodiments of the present application. Those of ordinary skill in the art may know that with the evolution of the system and the emergence of new business scenarios, the technical solutions provided by the embodiments of the present application are equally applicable to similar technical problems.

Exemplarily, it may also include a scenario where both hands are busy, specifically, when the user needs to use both hands to complete other tasks at the same time, the thumb may not be used freely. For example, the user is carrying an item or a heavy object, using a tool, or holding a cup of hot drink or a plate of food. It may also include a sports scenario, specifically, during sports, the user's thumb may be occupied by other needs or is not suitable for triggering. For example, the user is holding a kettle or a mobile phone while jogging, holding a handlebar while riding a bicycle, or pulling a fitness apparatus or a barbell while working out. It may also include a scenario of wearing gloves, in which wearing gloves will cover the surface of the ring, which will affect the capacitive touch recognition function of the touch area. For example, warm gloves are worn in winter, protective gloves are used in a laboratory, and protective gloves are worn for engineering operations. It may also include a scenario in a specific medical or health condition, and certain health conditions may limit the use of the thumb. For example, arthritis or other hand diseases, fatigue caused by long-term use of the thumb (such as excessive operations in a game), and special needs people, such as amputees or people with limited mobility. It may also include a scenario of wet or dirty hands. The user's hands are wet or stained with unclean substances, so avoid using the thumb to avoid affecting touch control. For example, the user is cooking or washing ingredients, or the hands are stained with soil or rain when the user is outdoors.

The technical solutions of the present application will be described in detail below with specific embodiments. The following specific embodiments may be combined with each other, and the same or similar concepts or processes may not be repeated in certain embodiments.

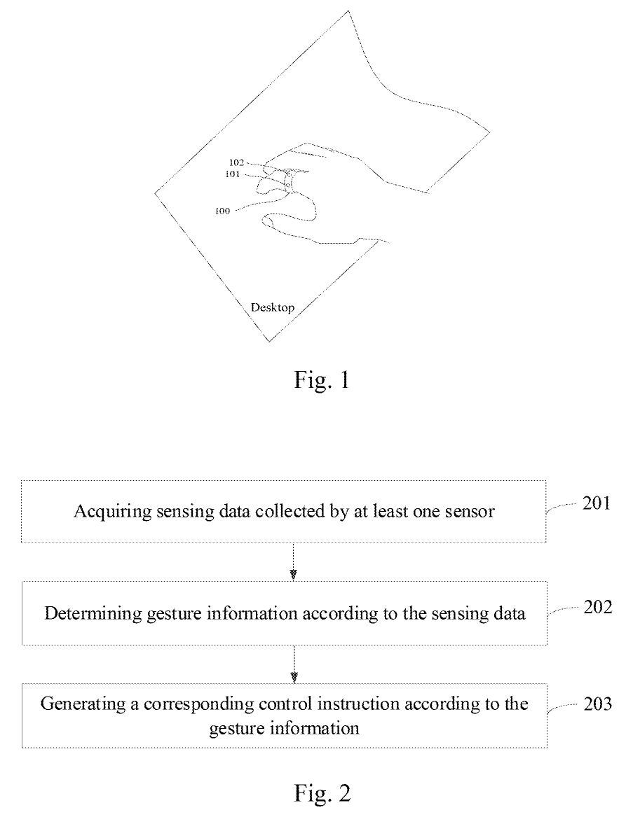

FIG. 2 is a first schematic flowchart of a control instruction generation method provided by embodiments of the present disclosure. As shown in FIG. 2, the control instruction generation method includes:

201, acquiring sensing data collected by at least one sensor.

The execution body of the embodiments of the present disclosure may be an intelligent ring, a controller of the intelligent ring, a terminal device or a server communicatively connected to the intelligent ring, etc.

Specifically, at least one sensor, such as an image sensor, an audio sensor, an inertial sensor, etc., may be provided in the intelligent ring, and each sensor collects corresponding sensing data, and after processing the collected sensing data or directly stores the collected sensing data in a storage space, so as to subsequently read the data from the storage space for processing and generate a control instruction.

In embodiments of the present disclosure, considering that the user may wear a plurality of intelligent devices at the same time, such as wearing an intelligent ring and intelligent glasses at the same time, data collected by a sensor of the intelligent glasses may also be acquired. Specifically, a communication link between the intelligent ring and the intelligent glasses may be established, and the intelligent ring sends a request to the intelligent glasses to enable the intelligent glasses to send image data to the intelligent ring, and the intelligent ring performs subsequent processing based on sensing data of its own sensor and image data collected by an image sensor of the intelligent glasses.

In embodiments of the present disclosure, the sensors may include at least one of: an inertial sensor, an audio sensor, a vibration sensor, a piezoelectric sensor, an optical sensor, an electromyographic sensor, or an image sensor.

Specifically, the number of sensors may be two or more, and the number and type of sensors may be determined specifically according to the characteristics of the gesture to be recognized, which is not limited in this embodiment.

Exemplarily, assuming that detecting a fist-making gesture by the hand wearing the intelligent ring is used as a basis for generating a wake-up instruction of the intelligent ring, then an inertial sensor, a pressure sensor and an electromyographic sensor may be provided in the intelligent ring. The acceleration, angular velocity, magnetic field direction, etc. of the fingers are detected by the inertial sensor, the electrical signal generated by the finger muscle activity is detected by the electromyographic sensor, and the pressure change between the fingers and the ring is detected by the pressure sensor when making a fist. The fist-making gesture may be recognized based on the sensing data collected by the three sensors, and then the wake-up instruction is generated after the fist-making gesture is detected.

In embodiments of the present disclosure, the acquiring the sensing data collected by the at least one sensor includes at least one of the following: a first item: acquiring inertial sensing data collected by an inertial sensor, where the inertial sensing data includes at least one of the following: acceleration data, angular velocity data, and magnetic field data; a second item: acquiring a sound signal collected by an audio sensor; a third item: acquiring a vibration signal collected by a vibration sensor; a fourth item: acquiring pressure data collected by a piezoelectric sensor; a fifth item: acquiring blood flow velocity data of a finger wearing the intelligent ring collected by an optical sensor; or a sixth item: acquiring an electromyographic signal collected by an electromyographic sensor.

202, determining gesture information according to the sensing data.

Specifically, after the sensing data is acquired, the gesture information may be determined in various manners. For example, a threshold determination manner may be used, in which the data collected by each sensor is compared with a corresponding threshold, and when the data collected by each sensor meets a corresponding condition (e.g., exceeds or is lower than a certain threshold), it is determined that a specific gesture occurs; or a template matching method may be used, in which firstly, a template may be created for each gesture, and the template includes feature data of the gesture; then, in practical applications, the sensing data is compared with the template to find a best-matching template, thereby determining the gesture type; or a deep learning model recognition manner may be used; or the above methods may be used in combination. This is not limited in the embodiments of the present disclosure.

In embodiments of the present disclosure, the gesture information includes any of the following: tapping action information of a finger wearing the intelligent ring, combined tapping action information of a finger wearing the intelligent ring and a finger not wearing the intelligent ring, or air gesture information of a hand wearing the ring.

In the embodiments of the present disclosure, the air gesture refers to a gesture that may be recognized without applying force to other objects. For example, making a fist and waving. It may be understood that when making a fist, if the fist is made with the hand on a desktop, the force of the desktop on the fist-making action may be ignored, so it may also be regarded as an air gesture.

203, generating a corresponding control instruction according to the gesture information.

Specifically, a correspondence between gestures and instructions may be preset, and after the gesture information is determined, the control instruction corresponding to the gesture information may be found from the correspondence.

In embodiments of the present disclosure, the control instruction includes at least one of: a wake-up instruction, a voice execution instruction, a shutdown instruction, a recording instruction, a photographing instruction, a call instruction, or an alarm instruction. The wake-up instruction is used to activate the intelligent ring from a sleep or lock screen state, so that it enters a state of waiting for user instructions. The voice execution instruction means that the user is allowed to control the intelligent device to perform a specific function through voice, for example, after the user sends a voice instruction "play xx music", the intelligent ring may execute the voice instruction after detecting a specific gesture. The shutdown instruction is used to turn off the intelligent ring, so that it stops working and enters a shutdown state. The recording instruction is used to start a recording function of the intelligent ring or an intelligent terminal connected to the intelligent ring to start recording audio. The photographing instruction is used to control a camera of the intelligent ring or the intelligent terminal connected to the intelligent ring to take a photo or record a video. The call instruction is used to control the intelligent ring or the intelligent terminal connected to the intelligent ring to make a call to a designated contact. The alarm instruction is used to trigger an alarm function of the intelligent ring in an emergency.

It may be seen from the above descriptions that in the embodiments, the corresponding gesture information is obtained through recognition based on the multimodal data collected by the at least one sensor, and the control instruction is generated based on the gesture information, thereby ensuring the accuracy of gesture recognition, improving the flexibility of controlling the intelligent ring, and thus improving the user experience.

In embodiments of the present disclosure, on the basis of the above embodiments, for example, on the basis of the embodiment shown in FIG. 2, in order to improve the accuracy of recognition, a model may be used for gesture recognition. Specifically, the determining the gesture information according to the sensing data may include: inputting the sensing data into a model to obtain the corresponding gesture information. In the embodiments of the present disclosure, the model may be a deep learning model such as a convolutional neural network, a recurrent neural network, and a model based on a Transformer mechanism, and may also be a traditional machine learning model such as a support vector machine, a decision tree and a random forest.

The model training uses a Transformer-based mechanism model to jointly train the multimodal data. By combining information of different modalities (such as IMU data and audio data), the model may use a self-attention mechanism to mine features within each modality, and learn the correlation and difference between modalities through a cross-modal attention mechanism, thereby effectively improving the recognition ability of the tapping action. In the process of model training, the model needs to score the "tapping event" data to generate a confidence value. The higher the confidence value, the more obvious the characteristics of the tapping event in the data.

Exemplarily, the training process may include the following steps: firstly, performing data preprocessing: performing feature extraction, normalization or standardization on the IMU data (such as acceleration and angular velocity) and audio data to ensure that different modal data are within the same value range; aligning in time: ensuring the consistency of the multimodal data in the time dimension through an interpolation or timestamp alignment method to facilitate subsequent model processing; secondly, performing feature encoding: encoding the IMU and audio data respectively using an embedding layer of the Transformer model to generate a fixed-length feature representation; thirdly, performing multimodal fusion: synthesizing information of each modality by using a method of early fusion (feature concatenating), intermediate fusion (fusion after independent extraction), or late fusion (fusion of prediction results); then, determining a training objective: designing a cross-entropy loss function for classification tasks, or using a contrastive loss function for contrastive learning to optimize the discrimination ability of the model; furthermore, designing positive and negative samples: constructing positive and negative sample sets to ensure that the model may accurately learn the features of the tapping action while avoiding misrecognition of background noise or other actions; finally, optimizing the model: training the model using AdamW or other optimization algorithms, and adjusting learning rate and regularization parameters to improve model performance.

In embodiments of the present disclosure, in order to improve the classification ability of the model for an event, enhance the understanding ability of the model to the difference between different modalities, prevent overfitting, and enhance the generalization ability of the model, positive samples and negative samples may be set in a training set. The model is obtained by training based on the positive samples and the negative samples, the positive samples are determined according to sensing data collected when a user makes a gesture, and the negative samples include samples determined according to sensing data collected when the user makes an action similar to the gesture.

In embodiments of the present disclosure, gesture recognition may be performed based on a fixed time interval to meet the real-time requirement of control. The inputting the sensing data into the model to obtain the corresponding gesture information may include: based on a period, inputting first sensing data within a duration before a current moment into the model to obtain a recognition result, where the duration is greater than the period; and determining the gesture information according to the recognition result.

In embodiments of the present disclosure, in order to avoid repeated triggering of instructions, after the gesture is detected, detection may be performed after a certain interval. Specifically, the inputting the first sensing data within the duration before the current moment into the model based on the period to obtain the recognition result may include: for each period, if the gesture information is not detected within the duration before the current moment, inputting the first sensing data within the duration before the current moment into the model to obtain the recognition result; and if the gesture information is detected within the duration before the current moment, there is no need to input the first sensing data within the duration before the current moment into the model.

In embodiments of the present disclosure, the recognition result includes candidate gesture information and a corresponding confidence value, and the determining the gesture information according to the recognition result may include: determining the candidate gesture information as the gesture information if the confidence value is greater than a threshold.

In embodiments of the present disclosure, in order to improve the accuracy of recognition, the threshold may be set to be dynamic. Specifically, the threshold is determined according to a change trend of the first sensing data.

Exemplarily, the threshold is set to be dynamic and adjusted according to the data within the time window. The threshold (for example, 97) is not fixed, but will be adjusted with the passage of time and changes in the data within the time window. That is, the system will re-evaluate and set a new threshold based on recent data performance (such as statistics, trends or patterns over a period of time). This ensures that the conditions for triggering instructions are more in line with the actual situation of the current data, rather than relying on a fixed value all the time.

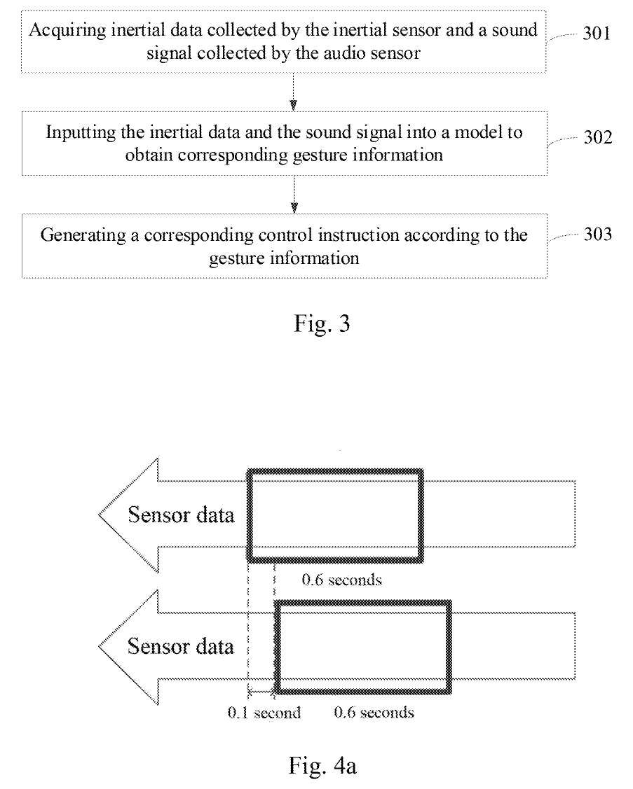

FIG. 3 is a second schematic flowchart of a control instruction generation method provided by embodiments of the present disclosure. In this embodiment, taking at least one sensor including an inertial sensor and an audio sensor as an example, the implementation process of control instruction generation is exemplarily described. The control instruction generation method includes:
301, acquiring inertial data collected by the inertial sensor and a sound signal collected by the audio sensor.
302, inputting the inertial data and the sound signal into a model to obtain corresponding gesture information.
303, generating a corresponding control instruction according to the gesture information.

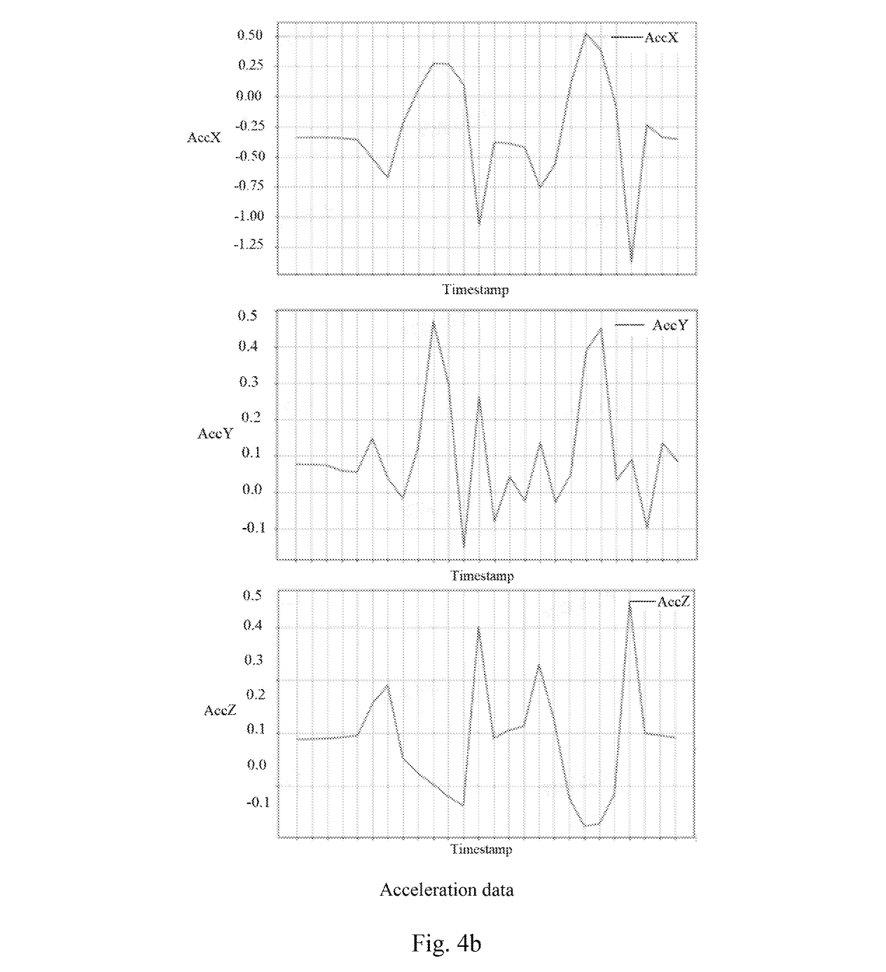

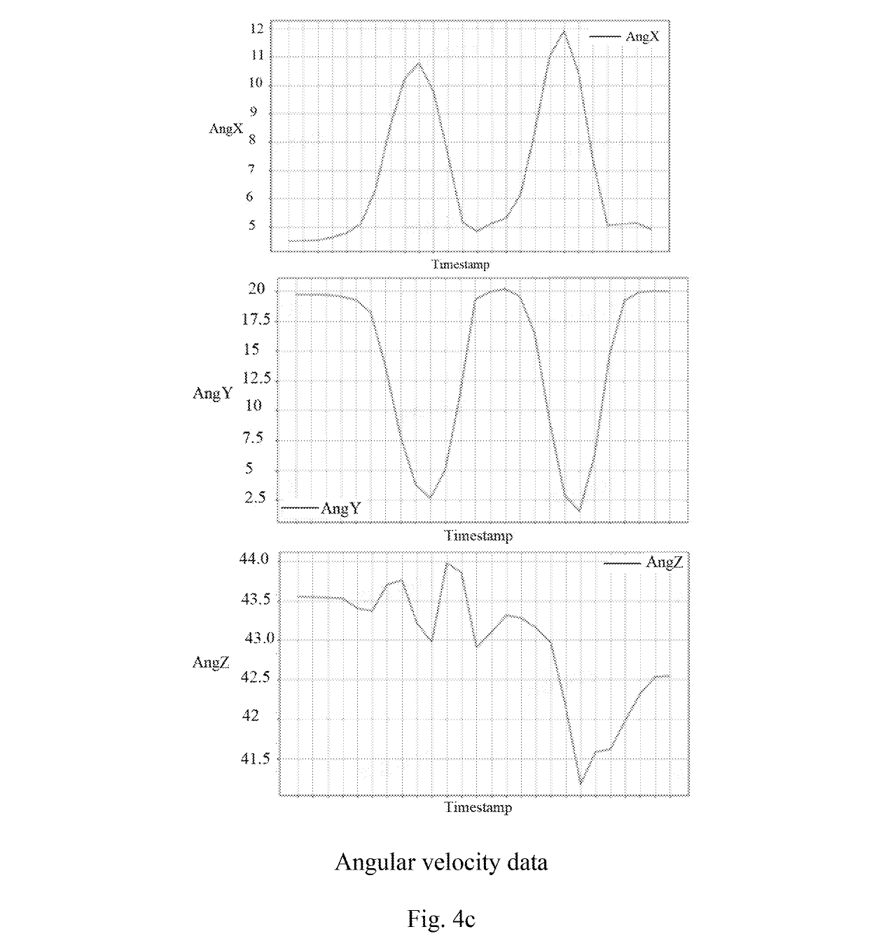

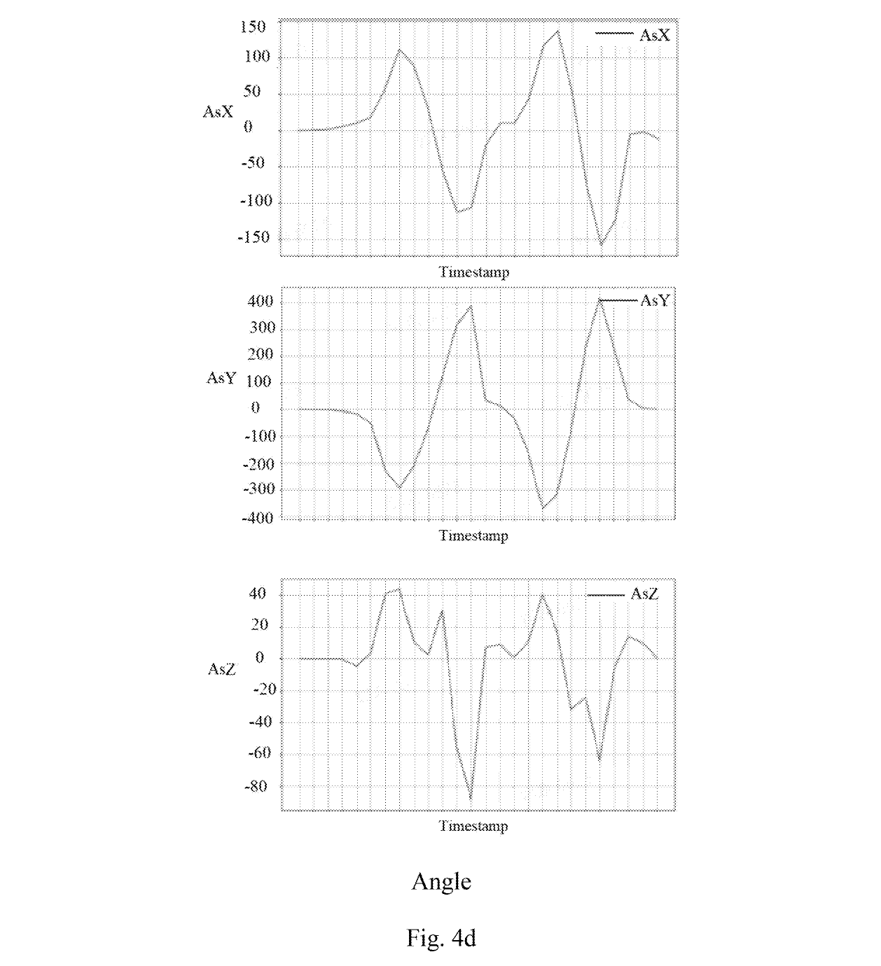

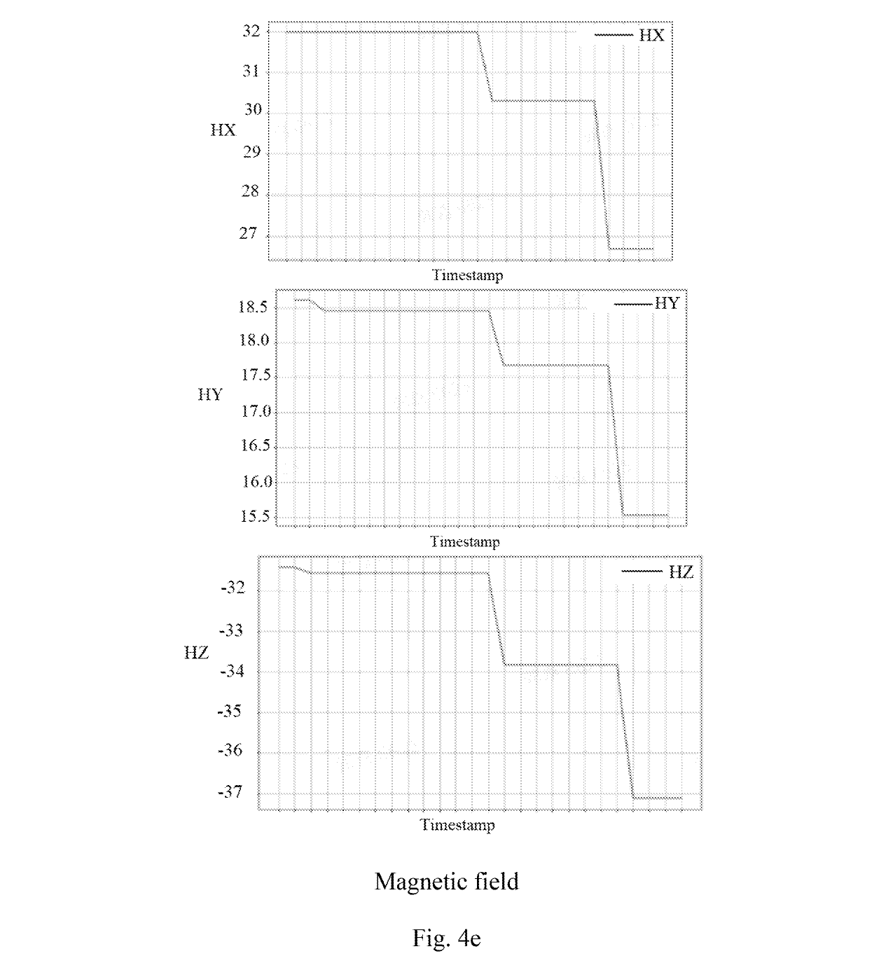

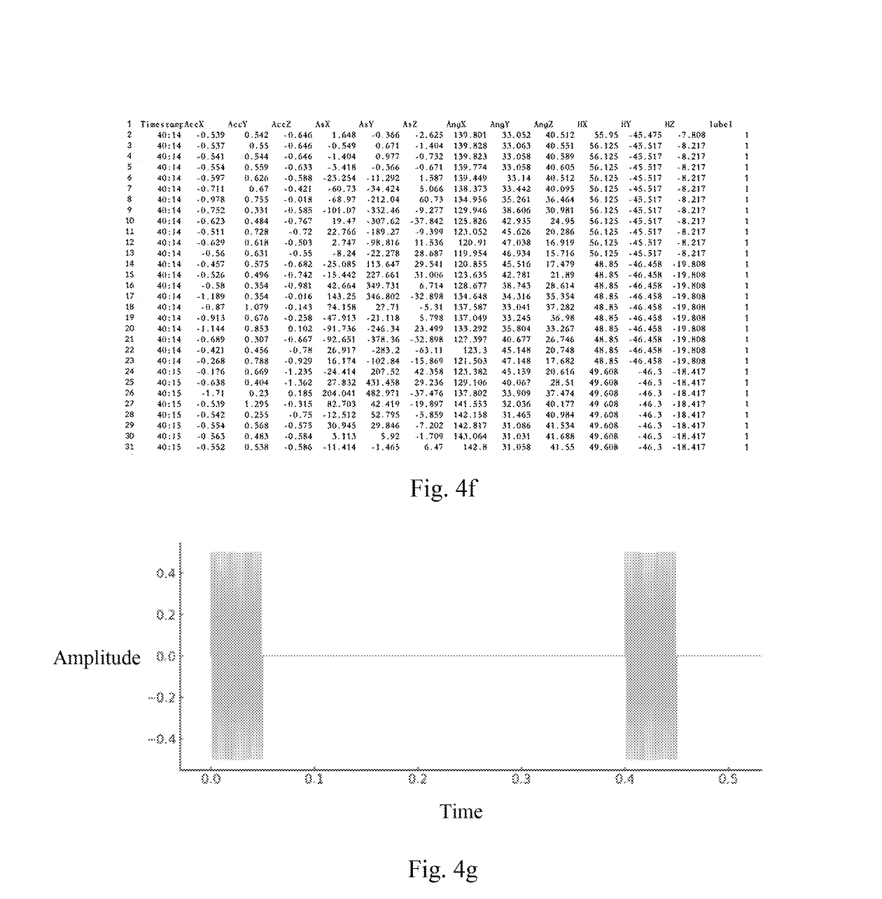

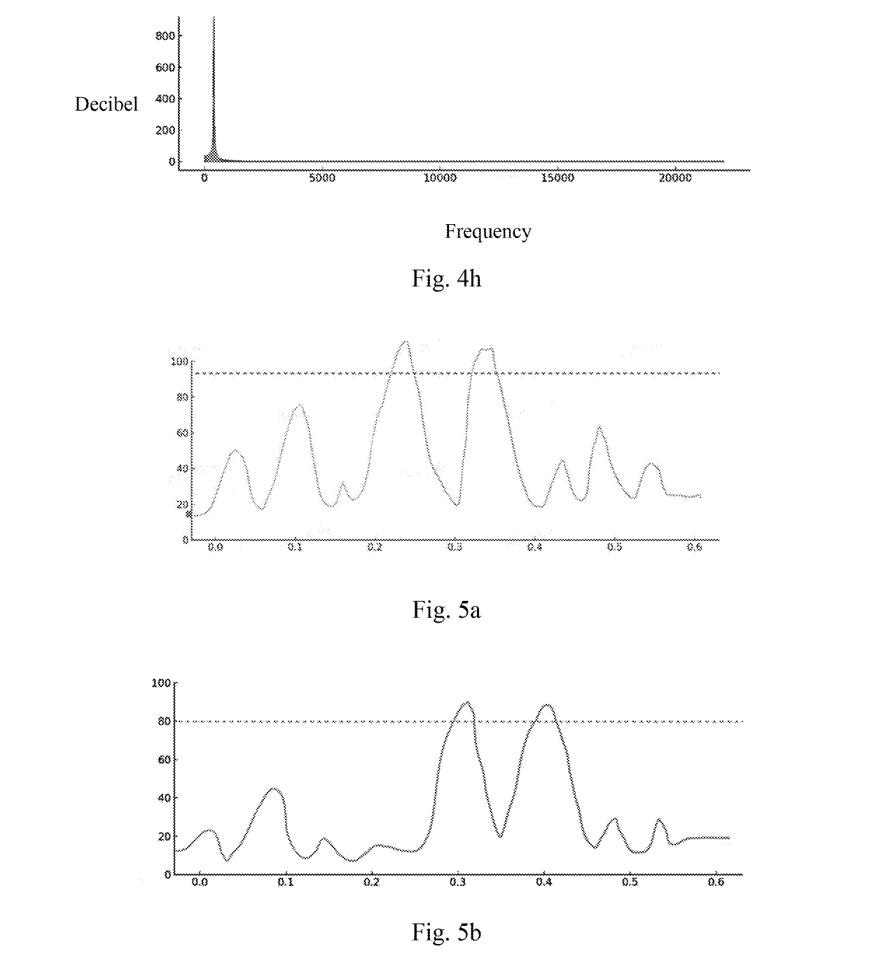

Specifically, various types of sensors capture real-time data signals. As shown in FIG. 4a, a cache module retains sensing data within a duration (e.g., 0.6 seconds), and uploads sensing data within 0.6 seconds at intervals of a period (e.g., 0.1 seconds). The sensing data is input into a trained local small model, and whether the sensing data within 0.6 seconds meets an event standard of a gesture (e.g., tapping with the index finger (twice)) is determined through the model. If it meets the standard, a confidence value is output based on the standard, and an instruction is triggered when the confidence value meets a threshold standard.

In embodiments of the present disclosure, in order to obtain a model through training, a dataset needs to be created first. Exemplarily, data samples of inertial sensing data may include acceleration data as shown in FIG. 4b, angular velocity data as shown in FIG. 4c, angle data as shown in FIG. 4d, and magnetic field data as shown in FIG. 4e. As shown in FIG. 4f, a table may be used to record the data samples. The time (Timestamp) represents the time mark of each row of data. The acceleration data (AccX, AccY, AccZ) represents the acceleration values in three directions (X, Y, and Z axes) of the acceleration sensor. The angular velocity (AsX, AsY, AsZ) represents the angular velocity in the X, Y, and Z directions. The angles (AngX, AngY, AngZ) represent the angles in the X, Y, and Z directions (possibly roll, pitch, and yaw angles). The magnetic field data (HX, HY, HZ) represents the magnetic field intensity in the X, Y, and Z directions. The label column (label) is used to classify or label the category of each group of data. This group of data is the feature of the tapping event. As shown in FIGS. 4g and 4h, audio data sampled after the user taps (twice) with the index finger within a duration (e.g., 0.6 seconds) may be used as one of the samples whose audio meets the event standard.

In embodiments of the present disclosure, in order to improve the classification ability of the model for an event, enhance the understanding ability of the model to the difference between different modalities, prevent overfitting, and enhance the generalization ability of the model, it is also necessary to generate negative sample data while creating a positive sample dataset. The positive samples refer to samples that meet an expected label or a task, such as data that meets a certain event condition (such as IMU and audio data of tapping with the index finger). Negative samples refer to samples that do not meet the task or label, such as random background noise, irrelevant IMU data, or other non-tapping events, such as mouse and typing.

In the embodiments of the present disclosure, reference may be made to the above embodiments for the model training process, which will not be repeated here. After the training is completed, the model may analyze sensor cache data within a duration (e.g., 0.6 seconds) and determine whether it contains a feature signal of a tapping event. For the detected "tapping event", the model not only outputs a classification result ("there is a tapping event" or "there is no tapping event"), but also provides a confidence value for the result of "there is a tapping event" to quantify the significance and confidence of the event feature. In addition, a final threshold standard may be set, and once the data meets the threshold, the instruction will be triggered. For example, assuming that the current threshold standard is 97, the instruction is triggered when the confidence value is greater than or equal to 97. In order to ensure that the conditions for triggering instructions are more in line with the actual situation of the current data, the threshold may be set to be dynamic and adjusted according to the data within the time window. That is, the threshold (for example, 97) is not fixed, but will be adjusted with the passage of time and changes in the data within the time window. That is, the system will re-evaluate and set a new threshold based on recent data performance (such as statistics, trends or patterns over a period of time). As shown in FIG. 5a, if the recent data fluctuates greatly, the system may increase the threshold to make the trigger conditions more stringent. As shown in FIG. 5b, if the data becomes more stable, the system may lower the threshold to make the trigger conditions more flexible.

In embodiments of the present disclosure, in order to avoid repeated triggering of instructions, after a piece of matching data is recognized, subsequent data that meets the matching condition will be ignored within a set time window (that is, the duration).

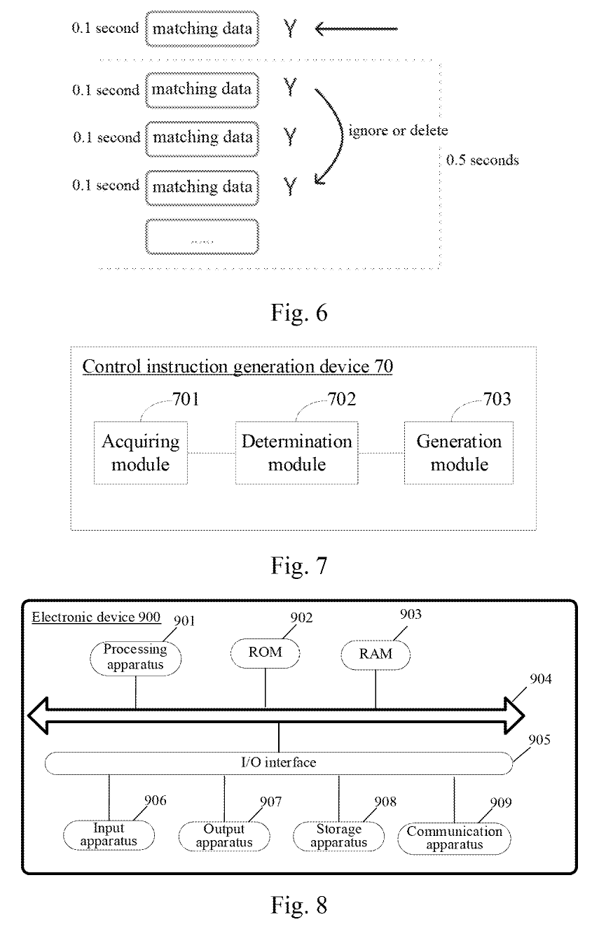

Exemplarily, as shown in FIG. 6, when the currently uploaded 0.6-second data meets the standard, the 0.6-second data that meets the standard and is uploaded every 0.1 second in the subsequent 0.5-second time window will be ignored or deleted to avoid repeated triggering of instructions.

It may be seen from the above descriptions that when the user uses a ring-type intelligent product, if the thumb is occupied and the interaction operation of touching the surface of the ring cannot be completed, a specific gesture (for example, tapping with the index finger) may be used to trigger the corresponding control instruction. Moreover, a model is obtained by training in combination with multimodal data, which effectively improves the recognition precision of the tapping action of the index finger, significantly reduces the occurrence of misoperation, and improves the user experience.

Corresponding to the control instruction generation method of the above embodiments, FIG. 7 is a structural block diagram of a control instruction generation device provided by embodiments of the present disclosure. For convenience of explanation, only parts related to the embodiments of the present disclosure are shown. Referring to FIG. 7, the device includes: an acquiring module 701, a determination module 702, and a generation module 703.

The acquiring module 701 is configured to acquire sensing data collected by at least one sensor.

The determination module 702 is configured to determine gesture information according to the sensing data.

The generation module 703 is configured to generate a corresponding control instruction according to the gesture information.

In embodiments of the present disclosure, the sensors include at least one of: an inertial sensor, an audio sensor, a vibration sensor, a piezoelectric sensor, an optical sensor, an electromyographic sensor, or an image sensor.

In embodiments of the present disclosure, the acquiring module 701 is further configured to: acquire inertial sensing data collected by the inertial sensor, where the inertial sensing data includes at least one of the following: acceleration data, angular velocity data, or magnetic field data; acquire a sound signal collected by the audio sensor; acquire a vibration signal collected by the vibration sensor; acquire pressure data collected by the piezoelectric sensor; acquire blood flow velocity data of a finger wearing the intelligent ring collected by the optical sensor; and acquire an electromyographic signal collected by the electromyographic sensor.

In embodiments of the present disclosure, the gesture information includes any of the following: tapping action information of a finger wearing the intelligent ring, combined tapping action information of a finger wearing the intelligent ring and a finger not wearing the intelligent ring, or air gesture information of a hand wearing the ring.

In embodiments of the present disclosure, the control instruction includes at least one of: a wake-up instruction, a voice execution instruction, a shutdown instruction, a recording instruction, a photographing instruction, a call instruction, or an alarm instruction.

In embodiments of the present disclosure, the determination module 702 is further configured to input the sensing data into a model to obtain the corresponding gesture information.

In embodiments of the present disclosure, the determination module 702 is further configured to: based on a period, input first sensing data within a duration before a current moment into the model to obtain a recognition result, where the duration is greater than the period; and determine the gesture information according to the recognition result.

In embodiments of the present disclosure, the determination module 702 is further configured to: for each period, if the gesture information is not detected within the duration before the current moment, input the first sensing data within the duration before the current moment into the model to obtain the recognition result; and if the gesture information is detected within the duration before the current moment, there is no need to input the first sensing data within the duration before the current moment into the model.

In embodiments of the present disclosure, the recognition result includes candidate gesture information and a corresponding confidence value, and the determination module 702 is further configured to: determine the candidate gesture information as the gesture information if the confidence value is greater than a threshold.

In embodiments of the present disclosure, the threshold is determined according to a change trend of the first sensing data.

In embodiments of the present disclosure, the sensing data includes inertial data and a sound signal, and the determination module 702 is further configured to input the inertial data and the sound signal into the model to obtain the corresponding gesture information.

In embodiments of the present disclosure, the model is obtained by training based on positive samples and negative samples, the positive samples are determined according to sensing data collected when a user makes a gesture, and the negative samples include samples determined according to sensing data collected when the user makes an action similar to the gesture.

The device provided by this embodiment may be used to implement the technical solutions of the above method embodiments, and the implementation principles and technical effects thereof are similar, which will not be repeated here in this embodiment.

In order to implement the above embodiments, embodiments of the present disclosure further provide an electronic device.

Reference is made to FIG. 8, which illustrates a schematic structural diagram of an electronic device 900 suitable for implementing the embodiments of the present disclosure, and the electronic device 900 may be a terminal device or a server. The terminal device may include, but is not limited to, an intelligent ring, a mobile terminal such as a mobile phone, a notebook computer, a digital broadcast receiver, a personal digital assistant (abbreviated as PDA), a tablet computer, a portable media player (abbreviated as PMP), a vehicle-mounted terminal (such as a vehicle navigation terminal), etc., and a fixed terminal such as a digital TV, a desktop computer, etc. The electronic device shown in FIG. 8 is only an example, and should not impose any limitation to the function and scope of use of the embodiments of the present disclosure.

As shown in FIG. 8, the electronic device 900 may include a processing apparatus (such as a central processing unit, a graphics processor, etc.) 901, which may perform various appropriate actions and processing according to a program stored in a read-only memory (abbreviated as ROM) 902 or a program loaded from a storage apparatus 908 into a random access memory (abbreviated as RAM) 903. The RAM 903 further stores various programs and data required for operations of the electronic device 900. The processing apparatus 901, the ROM 902, and the RAM 903 are connected to each other through a bus 904. An input/output (I/O) interface 905 is also connected to the bus 904.

Usually, the following apparatus may be connected to the I/O interface 905: an input apparatus 906 including, for example, a touch screen, a touchpad, a keyboard, a mouse, a camera, a microphone, an accelerometer, a gyroscope, etc.; an output apparatus 907 including, for example, a liquid crystal display (abbreviated as LCD), a speaker, a vibrator, etc.; a storage apparatus 908 including, for example, a magnetic tape, a hard disk, etc.; and a communication apparatus 909. The communication apparatus 909 may allow the electronic device 900 to perform wireless or wire communication with other devices to exchange data. Although FIG. 8 shows the electronic device 900 having various apparatuses, it should be understood that not all the apparatuses shown here need to be implemented or provided. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a computer-readable medium, where the computer program includes program code for performing the method shown in the flowchart. In such embodiments, the computer program may be downloaded and installed from a network through the communication apparatus 909, or installed from the storage apparatus 908, or installed from the ROM 902. When the computer program is executed by the processing apparatus 901, the above functions defined in the method of the embodiments of the present disclosure are executed.

It should be noted that the above computer-readable medium in the present disclosure may be a computer-readable signal medium, a computer-readable storage medium, or any combination of the two. The computer-readable storage medium may be, for example, but not limited to, an electronic, magnetic, optical, electromagnetic, infrared, or semiconductor system, apparatus or device, or any suitable combination of the above. More specific examples of the computer-readable storage medium may include, but are not limited to: an electrically connected portable computer disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated on a baseband or as a part of a carrier wave, and computer-readable program code is carried in the data signal. The data signal propagated in this way may be in various forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit the program used by or in combination with the instruction execution system, apparatus or device. The program code contained on the computer-readable medium may be transmitted by any suitable medium, including but not limited to: a wire, an optical cable, a radio frequency (RF), etc., or any suitable combination of the above.

The above computer-readable medium may be included in the above electronic device, or it may exist alone without being assembled into the electronic device.

The above computer-readable medium carries one or more programs, and when the one or more programs are executed by the electronic device, the electronic device executes the method shown in the above embodiments.

The computer program code for performing the operations of the present disclosure may be written in one or more programming languages or a combination thereof. The above programming languages include object-oriented programming languages such as Java, Smalltalk, C++, and conventional procedural programming languages such as "C" language or similar programming languages. The program code may be executed entirely on a user's computer, partly executed on a user's computer, executed as an independent software package, partly executed on a user's computer and partly executed on a remote computer, or entirely executed on a remote computer or server. In the case of involving a remote computer, the remote computer may be connected to a user's computer through any kind of network, including a local area network (Local Area Network, LAN for short) or a wide area network (Wide Area Network, WAN for short), or it may be connected to an external computer (for example, connected by using Internet provided by an Internet service provider).

The flowcharts and block diagrams in the drawings illustrate the possibly implemented architectures, functions and operations of the system, method and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and the combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented in a software manner, and may also be implemented in a hardware manner. The name of a unit does not constitute a limitation on the unit itself under certain circumstances, for example, the first obtaining unit may also be described as "a unit for obtaining at least two internet protocol addresses".

The foregoing functions described herein may be performed, at least in part, by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD) and more.

The above description is only preferred embodiments of the present disclosure and an explanation of the technical principles employed. Those skilled in the art should understand that the scope of disclosure involved in the present disclosure is not limited to the technical solutions formed by the specific combination of the above technical features, and should also cover, without departing from the above disclosed concept, other technical solutions formed by any combination of the above technical features or their equivalent features. For example, a technical solution formed by replacing the above features with technical features with similar functions disclosed in the present disclosure (but not limited thereto).

Additionally, although operations are depicted in a particular order, it should not be understood that these operations are required to be performed in a specific order as illustrated or in a sequential order. Under certain circumstances, multitasking and parallel processing may be advantageous. Likewise, although several specific implementation details are included in the foregoing discussion, these should not be interpreted as limitations on the scope of the present disclosure. Certain features that are described in the context of separate embodiments may also be implemented in combination in a single embodiment. Conversely, various features that are described in the context of a single embodiment may also be implemented in various embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms for implementing the claims.

1. A control instruction generation method, wherein the method is applied to an intelligent ring, the intelligent ring comprises at least one sensor, and the method comprises:
acquiring sensing data collected by the at least one sensor;
acquiring gesture information according to the sensing data; and
generating a corresponding control instruction according to the gesture information.

2. The method of claim 1, wherein the at least one sensor comprises at least one of: an inertial sensor, an audio sensor, a vibration sensor, a piezoelectric sensor, an optical sensor, an electromyographic sensor, or an image sensor.

3. The method of claim 1, wherein the acquiring the sensing data collected by the at least one sensor comprises at least one of:
acquiring inertial sensing data collected by an inertial sensor, wherein the inertial sensing data comprises at least one of: acceleration data, angular velocity data, or magnetic field data;
acquiring a sound signal collected by an audio sensor;
acquiring a vibration signal collected by a vibration sensor;
acquiring pressure data collected by a piezoelectric sensor;
acquiring blood flow velocity data of a finger wearing the intelligent ring collected by an optical sensor; or
acquiring an electromyographic signal collected by an electromyographic sensor.

4. The method of claim 1, wherein the gesture information comprises:
tapping action information of a finger wearing the intelligent ring;
combined tapping action information of a finger wearing the intelligent ring and a finger not wearing the intelligent ring; or
air gesture information of a hand wearing the ring.

5. The method of claim 1, wherein the control instruction comprises at least one of: a wake-up instruction, a voice execution instruction, a shutdown instruction, a recording instruction, a photographing instruction, a call instruction, or an alarm instruction.

6. The method of claim 1, wherein the acquiring the gesture information according to the sensing data comprises:
inputting the sensing data into a model to obtain the corresponding gesture information.

7. The method of claim 6, wherein the inputting the sensing data into the model to obtain the corresponding gesture information comprises:
inputting, based on a period, first sensing data within a duration before a current moment into the model to obtain a recognition result, wherein the duration is greater than the period; and
acquiring the gesture information according to the recognition result.

8. The method of claim 7, wherein the inputting, based on the period, the first sensing data within the duration before the current moment into the model to obtain the recognition result comprises:
for each period,
inputting, in response to the gesture information being not detected within the duration before the current moment, the first sensing data within the duration before the current moment into the model to obtain the recognition result; and
exclude inputting, in response to the gesture information being detected within the duration before the current moment, the first sensing data within the duration before the current moment into the model.

9. The method of claim 7, wherein the recognition result comprises candidate gesture information and a corresponding confidence value, and the acquiring the gesture information according to the recognition result comprises:
selecting, in response to the confidence value being greater than a threshold, the candidate gesture information as the gesture information.

10. The method of claim 9, wherein the threshold is related with a change trend of the first sensing data.

11. The method of claim 6, wherein the sensing data comprises inertial data and a sound signal, and the inputting the sensing data into the model to obtain the corresponding gesture information comprises:
inputting the inertial data and the sound signal into the model to obtain the corresponding gesture information.

12. The method of claim 6, wherein the model is obtained by training based on positive samples and negative samples, the positive samples are obtained according to sensing data collected in response to a user making a gesture, and the negative samples comprise samples obtained according to sensing data collected in response to the user making an action similar to the gesture.

13. An electronic device, comprising: a processor and a memory;
the memory stores a computer-executable instruction; and
the processor executes the computer-executable instruction stored in the memory to cause the processor to:
acquire sensing data collected by the at least one sensor;
acquire gesture information according to the sensing data; and
generate a corresponding control instruction according to the gesture information.

14. A non-transitory computer-readable storage medium, wherein a computer-executable instruction is stored in the computer-readable storage medium, and when the computer-executable instruction is executed by a processor, cause the processor to:
acquire sensing data collected by the at least one sensor;
acquire gesture information according to the sensing data; and
generate a corresponding control instruction according to the gesture information.

15. The electronic device of claim 13, wherein the at least one sensor comprises at least one of: an inertial sensor, an audio sensor, a vibration sensor, a piezoelectric sensor, an optical sensor, an electromyographic sensor, or an image sensor.

16. The electronic device of claim 13, wherein the acquiring the sensing data collected by the at least one sensor comprises at least one of:
acquiring inertial sensing data collected by an inertial sensor, wherein the inertial sensing data comprises at least one of: acceleration data, angular velocity data, or magnetic field data;
acquiring a sound signal collected by an audio sensor;
acquiring a vibration signal collected by a vibration sensor;
acquiring pressure data collected by a piezoelectric sensor;
acquiring blood flow velocity data of a finger wearing the intelligent ring collected by an optical sensor; or
acquiring an electromyographic signal collected by an electromyographic sensor.

17. The electronic device of claim 13, wherein the gesture information comprises:
tapping action information of a finger wearing the intelligent ring;
combined tapping action information of a finger wearing the intelligent ring and a finger not wearing the intelligent ring; or
air gesture information of a hand wearing the ring.

18. The electronic device of claim 13, wherein the control instruction comprises at least one of: a wake-up instruction, a voice execution instruction, a shutdown instruction, a recording instruction, a photographing instruction, a call instruction, or an alarm instruction.

19. The electronic device of claim 13, wherein the acquiring the gesture information according to the sensing data comprises:
inputting the sensing data into a model to obtain the corresponding gesture information.

20. The electronic device of claim 19, wherein the inputting the sensing data into the model to obtain the corresponding gesture information comprises:
inputting, based on a period, first sensing data within a duration before a current moment into the model to obtain a recognition result, wherein the duration is greater than the period; and
acquiring the gesture information according to the recognition result.
